(19) United States
(12) Patent Application Publication
(10) Pub. No.: US 2026/0170304 A1
(43) Pub. Date: Jun. 18, 2026

(54) ADVERSARIAL TRAINING OF CLASSIFIERS TO LEARN EXPLAINABLE FEATURES

(71) Applicant: Optum, Inc., Minnetonka, MN (US)

(72) Inventors: Sanjit Singh BATRA, Millbrae, CA (US); Jun HAN, Union City, NJ (US); Robert Elliott TILLMAN, Long Island City, NY (US)

(21) Appl. No.: 18/980,226

(22) Filed: Dec. 13, 2024

(51) Int. Cl. G06N 3/0455; G06N 3/084

(52) U.S. Cl. CPC G06N 3/0455; G06N 3/084

(57) ABSTRACT

Various embodiments of the present disclosure provide an improved adversarial training technique that improves the functionality of a computer in various aspects by to removing spurious correlations within machine learning models. The techniques comprise receiving, from an embedding layer of a machine learning encoder, a set of token embeddings associated with a labeled data object. The techniques comprise generating a set of perturbed token embeddings by applying a noise hyperparameter to a portion of the set of token embeddings, providing, to an encoding layer of the machine learning encoder, the set of perturbed token embeddings to generate a perturbed encoded representation of the labeled data object, and providing the perturbed encoded representation for training a classifier model based on the perturbed encoded representation and a label for the labeled data object.

### BACKGROUND

Machine learning models, such as classifiers used for text, image, and/or audio classification tasks, often face difficulties in learning robust and generalizable features from input data. One such challenge is a machine learning classifiers inability to differentiate between frequently reoccurring spurious features that should not impact the classification of the classifier and explainable features that should impact the classification of the classifier. Historically, this leads to overfitting on spurious correlations and/or irrelevant patterns present in training datasets, leading to poor performance on real-world data that may not exhibit the same characteristics.

Traditional approaches to training text classifiers have relied on standard supervised learning techniques, where models are trained on labeled datasets without explicit mechanisms to prevent the learning of spurious features. This has resulted in classifiers that may achieve high accuracy on training and validation sets but fail to generalize well to new, unseen data. Additionally, these models often lack interpretability, making it challenging to understand the basis of their predictions and identify potential biases and/or errors in their decision-making processes. Attempts to address these issues have included various data augmentation techniques and/or regularization methods. However, these approaches entail complex modifications to model architectures, loss functions, or optimization functions, making them difficult to implement and potentially limiting their applicability across different types of models and tasks.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of an adversarial training technique in accordance with some embodiments of the present disclosure.

FIG. 5 depicts an operational example of a portion of a machine learning encoder in accordance with some embodiments of the present disclosure.

FIG. 6 is a flowchart diagram of an example adversarial training process in accordance with some embodiments of the present disclosure.

### DETAILED DESCRIPTION

Various embodiments of the present disclosure provide machine learning architectures and techniques that improve the functionality of computer systems with respect to training machine learning models. To do so, some embodiments of the present disclosure provide an adversarial training scheme that introduces controlled noise into the embedding layer of an encoder model to break spurious correlations and improve model generalization. By doing so, the adversarial training scheme of the present disclosure may improve the accuracy of any machine learning model without a tradeoff in training speed or complexity. For example, and as described herein, traditional machine learning training techniques may fail to distinguish between spurious and explainable features, which lead classifier model to learn spurious feature correlations associated with output labels and results in poor generalization, explainability, and reduced accuracy. The adversarial training scheme of the present disclosure addresses this challenge by introducing a noise hyperparameter (α) and a gaussian noise matrix that controls the application of gaussian noise to token embeddings during a training process. By perturbing the token embeddings in a controlled manner, the adversarial training techniques of the present disclose may enable a classifier model to focus on true predictive features (e.g., explainable features) rather than spurious correlations, leading to improved robustness, generalization, and accuracy of model. Moreover, unlike traditional techniques for addressing spurious feature correlations, the adversarial training scheme of the present disclosure may be controlled by a single hyperparameter without modifications to a model's architecture, loss function, or optimization techniques. This reduced complexity afforded by the adversarial training scheme enables the broad application of the technique in a generalizable manner across different model architectures, training schemes, and optimization approaches. Moreover, the adversarial training scheme is applied to the continuous outputs of an embedding layer making it generalizable to any input data type and/or any data type specific classifier model. In this way, the adversarial training technique enables improves training operations that, when implemented by a computer, improves the speed, efficacy (in terms of trained model accuracies), and generalizability of machine learning training tasks.

Examples of technologically advantageous embodiments of the present disclosure comprise (i) a distribution of functionality within a traditional machine learning encoder that improves the efficacy of training operations for that encoder and downstream models, (ii) particular structures of adversarial training mechanisms, such as a gaussian noise matrix and noise hyperparameter, that may be applied within an adversarial training scheme, (iii) a particular way of training a machine learning model that addresses challenge in machine learning training, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

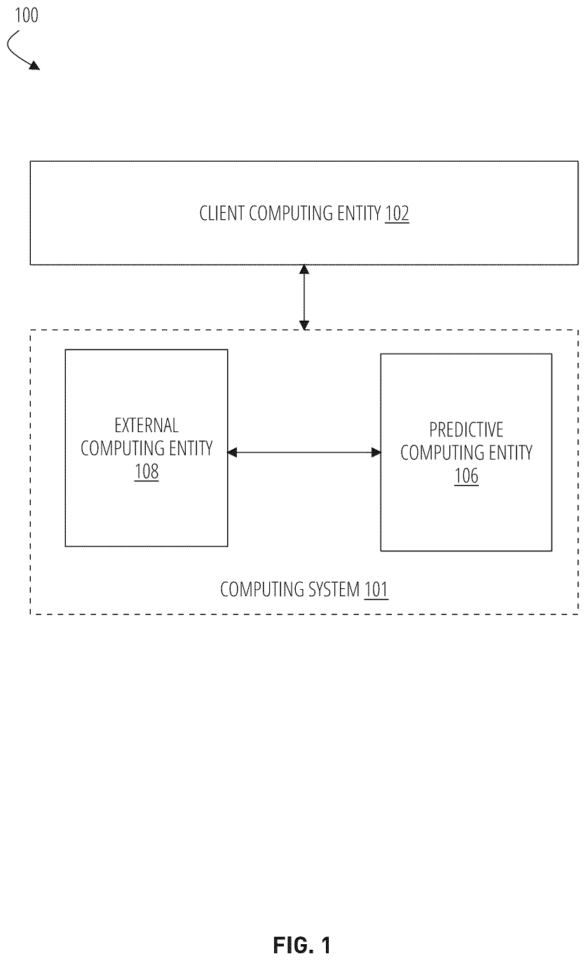

FIG. 1 depicts a block diagram of an example architecture 100 in accordance with some embodiments of the present disclosure. The architecture 100 comprises a computing system 101 configured to receive a request, such as an adversarial training request, and/or the like, from client computing entities 102, process the request, and provide the responses, such as perturbed training pairs, to the client computing entities 102. The example architecture 100 may be used in a plurality of domains and not limited to any specific application as disclosed herewith. The plurality of domains may comprise healthcare, industrial, manufacturing, computer security, and/or the like to name a few.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., feature encoding, machine learning training techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as training datasets, perturbed training datasets, and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

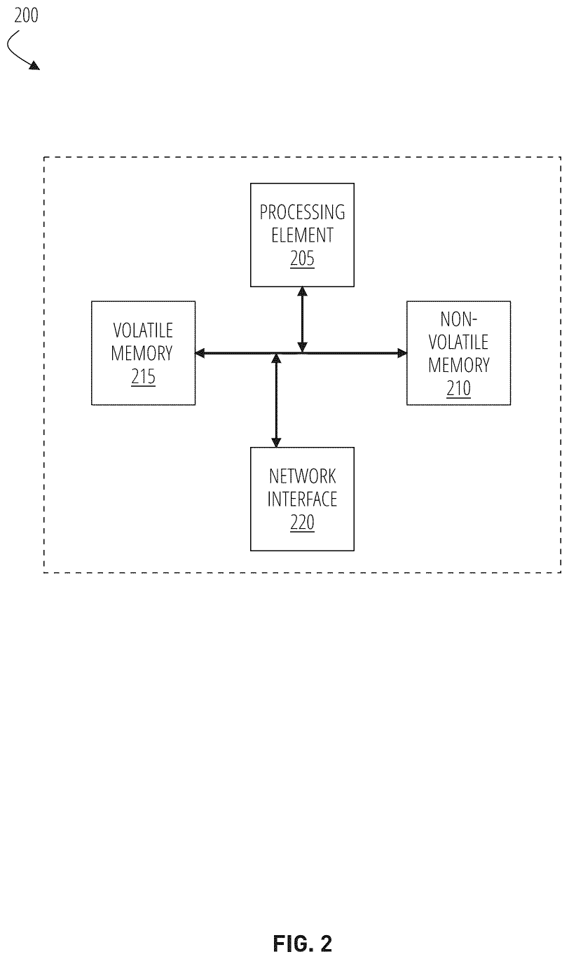

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

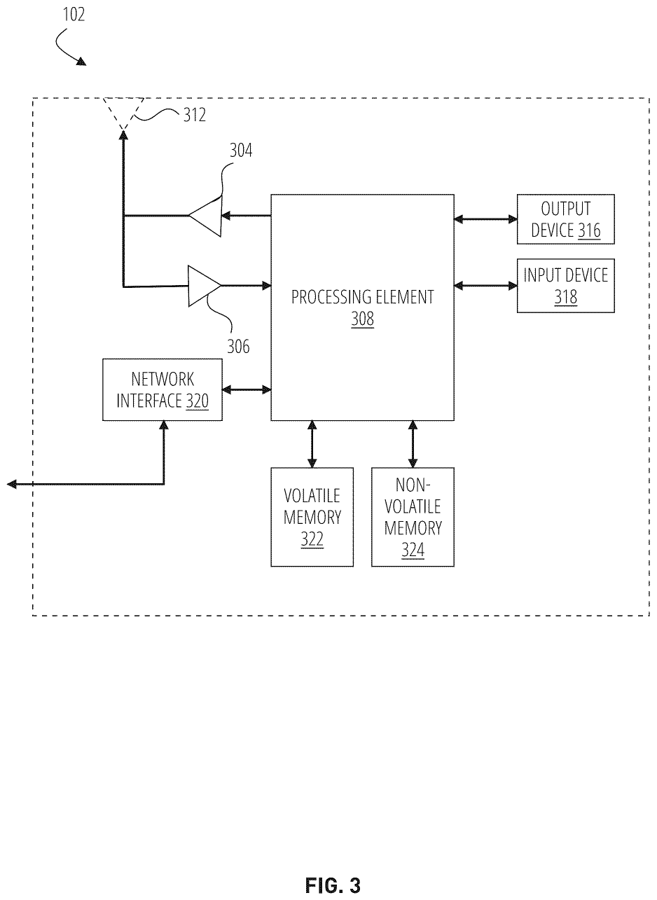

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to computer functionality, such as machine learning training. In particular, systems and methods are disclosed herein that implement adversarial training techniques to improve the performance (e.g., in terms of accuracy) of machine learning models in various domains. By doing so, the adversarial training techniques of the present disclosure enable improved model training processes that, when executed on a computer, improves the efficacy of various training tasks (e.g., back propagation of errors, feature encoding). This, in turn, may improve the functionality of a computer with respect to various computing tasks, including machine learning training, feature encoding, classification, and the like.

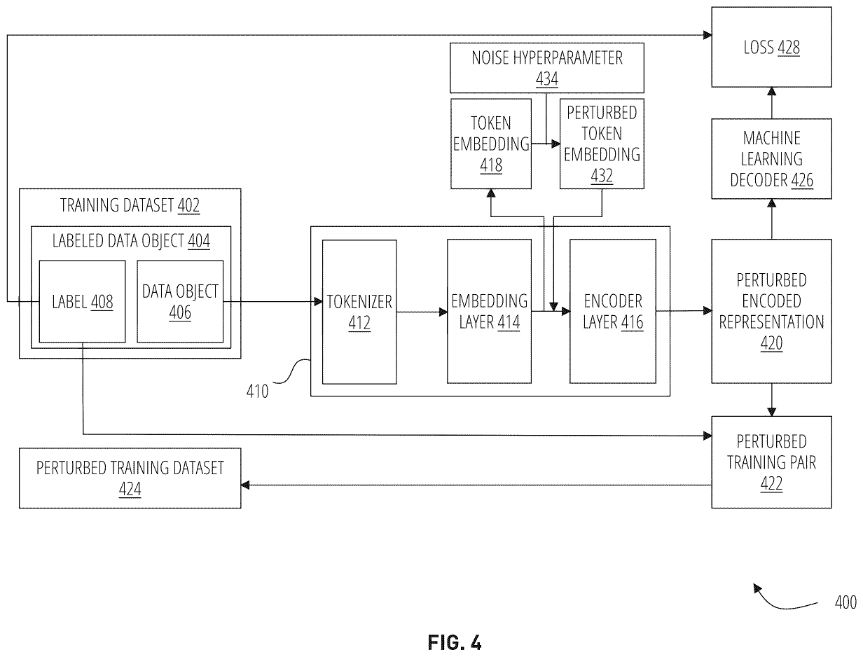

FIG. 4 depicts a dataflow diagram 400 of an adversarial training technique in accordance with some embodiments of the present disclosure. The adversarial training technique may be applied to an encoder-only, decoder-only, and/or encoder-decoder classifier model to break spurious feature correlations and thereby improve the performance of the classifier model by focusing correlations on explainable, non-spurious features. To do so, the adversarial training technique may apply noise to an intermediate output of a machine learning encoder 410 to disrupt spurious features before their patterns are learned by subsequent layers of the machine learning encoder 410. In this manner, a perturbed encoded representation 420 may be output from the machine learning encoder 410 that forces a downstream machine learning decoder 426 to learn explainable, non-spurious features, rather than spurious features that, if left unperturbed, may be weighted disproportionality in an encoded representation. As shown in the dataflow diagram 400 the perturbed encoded representation 420 may be input to the machine learning decoder 426 to train the machine learning decoder 426 (and/or the machine learning encoder 410 and machine learning decoder 426 end-to-end) and/or stored as a perturbed training pair 422 within a perturbed training dataset 424. In the later case, the perturbed training dataset 424 may be used to train and/or retrain a classifier model at a time subsequent to the generation of the perturbed encoded representation 420. In this way, the adversarial training technique may enable an improved machine learning training processes that improve the performance (e.g., in terms of accuracy, recall, and/or any other desired performance metric) and maintenance of classifier models.

In some embodiments, the computing system 101 receives a training dataset 402 for a classifier model that comprises a set of labeled data objects 404. In some examples, up to each of the set of labeled data objects 404 comprises a label 408 and a data object 406. In some examples, the data object 406 may comprise a set of features. For instance, the data object 406 may comprise at least one of a (i) text-based object with a set of term features and/or (ii) an image-based object with a set of image features.

In some embodiments, the training dataset 402 is a data structure that comprise a set of a labeled data objects 404 for a classifier model. The training dataset 402, for example, may comprise a set of labeled data objects 404 with labels 408 that may serve as ground truths for training a supervised machine learning model via a supervised training algorithm. In this regard, the training dataset 402 may comprise a set of input-output pairs, such as the labeled data objects 404, such that an input (e.g., data object 406) may be provided to the classifier model to generate a prediction that may be compared to the output (e.g., label 408) to determine a loss 428 that measures a performance (e.g., in terms of accuracy) of the train classifier model. By way of example, the training dataset 402 may be used in an iterative process where a classifier model generates a prediction on the input, compares the prediction to a label, and adjusts its internal parameters to minimize the difference between the predictions and the label. This process, known as supervised learning, allows the classifier model to learn the underlying patterns and relationships in the data that are predictive of the labels. As described herein, in traditional training techniques, such patterns are learned for both spurious (e.g., irrelevant features) and non-spurious features (e.g., relevant features), which may reduce the accuracy of classifier models trained with a training dataset 402 that includes spurious features (e.g., a header across each data object, a similar author).

In some examples, the training dataset 402 may comprise a different set of labeled data objects 404 based on a prediction domain, the model architecture of the classifier model, a type of prediction, and/or the like. For example, the training dataset 402 may comprise image data, text data, video data, audio data, and/or any other combination data type and/or derivative thereof. In some examples, the training dataset 402 may comprise a set of text-based objects and the classifier model may be trained, using the text-based objects, to generate a text-based prediction. In addition, or alternatively, the training dataset 402 may comprise a set of image-based object and the classifier model may be trained, using the image-based objects, to generate an image classification.

In some embodiments, a labeled data object 404 is a training entry within a training dataset 402. The labeled data object 404 may comprise a data object 406 (e.g., an input) and a label 408 (e.g., a ground truth). The data object 406 may comprise a unit of information of various forms depending on the nature of the machine learning task. For text classification tasks, the data object 406 may comprise document, a sentence, a sequence of tokens, and/or the like. For an image classification task, the data object 406 may comprise a digital image represented as a matrix of pixel values. As another example, for structured data tasks, the data object 406 may comprise a vector of features and/or attributes. The label 408 may comprise a data value that identifies a correct classification and/or prediction for the corresponding data object 406. The label 408 may comprise one or more different data types depending on the machine learning task. For example, for a binary classification task, the label 408 may comprise a binary value (e.g., 0 or 1, true or false) indicating which of the two possible classes the data object 406 belongs to. As another example, for non-binary classification tasks, the label 408 may comprise a probabilistic value (e.g., for a range prediction), a categorical value (e.g., for multi-classification tasks), and/or any other of data type from which a prediction may be derived. The label 408 may serve as a ground truth for a data object 406 as it may be assumed to be the correct answer against which a classifier model's prediction may be compared during training, evaluation, and/or validation.

In some embodiments, the training dataset 402 is divided into one or more training, testing, and/or validation sets. For example, a first subset of a set of labeled data objects 404 within the training dataset 402 may be partitioned as a training subset of labeled data objects 404. In some examples, a second subset of the set of labeled data objects 404 within the training dataset 402 may be partitioned as a testing subset of labeled data objects 404. In addition, or alternatively, the third subset of a set of labeled data objects 404 within the training dataset 402 may be partitioned as a validation subset of labeled data objects 404. The size of the first subset, the second subset, and/or the third subset may comprise a defined size and/or may be dependent on a size of the set of labeled data objects 404. For example, first subset of labeled data object 404 may comprise 70% of the set of labeled data object 404, the second subset of labeled data objects 404 may comprise 20% of the set of labeled data object 404, and/or the third subset of labeled data objects 404 may comprise 10% of the set of labeled data objects 404. Any other sizes and/or distributions may be used. In some examples, the adversarial training techniques of the present disclosure may be applied to the first subset of training labeled data objects 404 to improve the performance of the trained classifier model. In addition, or alternatively, the adversarial training techniques may not be applied to the second and third subsets of testing and evaluation labeled data objects to test and/or validate the trained classifier model on unperturbed representations (e.g., real world samples).

In some embodiments, the computing system 101 provides the data object 406 of a labeled data object 404 to a machine learning encoder 410. The machine learning encoder 410 may comprise a standalone encoder-only model and/or an encoder portion of an encoder-decoder classifier model. For example, the machine learning encoder 410 may comprise an encoder portion of a classifier model comprising an encoder-decoder machine learning architecture that comprises the machine learning encoder 410 and a machine learning decoder 426. In addition, or alternatively, the machine learning encoder 410 may comprise an encoder-only model that may provide an embedding representation to one or more different decoder-only classifier models.

In some embodiments, an encoder-decoder classifier model comprises a machine learning model with a connected encoder and decoder portion that collectively operate to generate an encoded representation of a data object 406 and then generate a prediction based on the encoded representation of the data object 406. The encoder-decoder classifier model may comprise any type of machine learning architecture, such a neural network (e.g., recurrent neural network, convolutional neural network), that may be trained, using supervised training techniques, to encode relationships between features of a data object and then decode the learned relationship into a prediction.

In some examples, an encoder portion (e.g., the machine learning encoder 410) of the encoder-decoder classifier model may comprise a first series of neural network layers that take the data object 406 and transform the data object 406 input a compact, encoded representation. The encoded representation may capture salient features of the data object 406 in a format that is more suitable for the classification task. The encoder portion may use various techniques, such as convolutional layers for image data, recurrent layers for sequential data, and/or the like, to effectively capture the relevant information from the data object 406 based on different input data types.

In some examples, the decoder portion (e.g., the machine learning decoder 426) of the encoder-decoder classifier model may comprise a second series of neural network layers that takes the encoded representation produced by the encoder portion and transforms the encoded representation input a prediction (e.g., a binary classification, a probabilistic confidence score). By way of example, the machine learning decoder 426 may comprise one or more fully connected layers followed by an output layer with an activation function (e.g., a sigmoid activation function) that produces a probability score for one or more prediction classes (e.g., a positive or negative class in a binary classification task).

In some examples, the encoder-decoder classifier model may be trained end-to-end using supervised learning techniques, with the encoder and decoder portions optimized jointly to minimize a loss function, such as binary cross-entropy. In addition, or alternatively, the encoder-decoder classifier model may be trained in one or more different stages. In a first stage, for example, the weights, parameters, and/or coefficients of an encoder portion may be frozen while the weights, parameters, and/or coefficients of a decoder portion are trained (e.g., using backpropagation of errors via gradient descent). In addition, or alternatively, in a second stage, the weights, parameters, and/or coefficients of an decoder portion may be frozen while the weights, parameters, and/or coefficients of an encoder portion are trained (e.g., using backpropagation of errors via gradient descent).

In some embodiments, the machine learning encoder 410 is an encoder-only machine learning model and/or an encoder portion of the encoder-decoder classifier model. The machine learning encoder 410, for example, may comprise any type of model architecture, such a neural network (e.g., recurrent neural network, convolutional neural network), that may be trained, using supervised training techniques, to encode relationships between features of a data object. For instance, the machine learning encoder 410 may comprise a tokenizer 412, an embedding layer, and/or one or more encoder layers (e.g., neural networks) designed to transform input data into a compact, encoded representation that captures the essential features of the data object 406.

In some embodiments, the machine learning encoder 410 comprises a series of layers of neural network operations, such as the tokenizer 412, a subsequent embedding layer 414, and/or one or more encoder layers 416 (e.g., neural network layers, recurrent neural network layers, convolution neural network layers.). These layers progressively transform the data object 406 into increasingly abstract representations. By way of example, the machine learning encoder 410 may comprise a tokenizer 412 that converts a set of features from a data object 406 to a set of tokens. In addition, or alternatively, the machine learning encoder 410 may comprise an embedding layer 414 that may convert the set of tokens 504 into a continuous token embedding 418. The embedding layer 414 may be followed by one or more subsequent encoding encoder layers 416 that process token embedding 418 through one or more attention mechanism (e.g., multi-head attention, self-attention) to modify the initial, token embedding based on relationships between the features of the data object 406. Up to each of the embedding layer 414 and/or one or more encoder layers 416 may comprise recurrent neural networks (RNNs), long short-term memory (LSTM) networks, transformer-based architectures (e.g., bidirectional encoder representations from transformers (BERT)), and/or the like. The output of the machine learning encoder 410 may comprise an encoded representation of the data object 406, which may comprise a fixed-size vector and/or a sequence of vectors that represent the encoded features of the data object 406.

In some embodiments, the computing system 101 generates, using the tokenizer 412 of the machine learning encoder 410, a set of feature tokens 506 that respectively correspond to the set of features 502 of a data object 406. In some embodiments, the tokenizer 412 comprises a first layer of the machine learning encoder 410 that is designed to map a feature token (e.g., a numerical index) to up to each feature (e.g., term) within the data object 406. In this manner, the tokenizer 412 may convert complex data types, such as text, images, audio, structured data, into tokens that may be processed by subsequent layers of the machine learning encoder 410.

In some embodiments, the tokenizer 412 converts a data object 406 into a set of feature tokens 506 through one or more preprocessing operations. For instance, the tokenizer 412 may apply one or more segmentation techniques to split the data object 406 into individual features (e.g., terms, pixels). The segmentation techniques, for example, may leverage whitespaces, punctuation, and/or one or more other rule-based and/or machine learning approaches to extract the set of features from the data object 406. In some examples, the tokenizer 412 may apply a unique and/or random token mapping model to the extracted features to generate the set of tokens. For instance, the tokenizer 412 may randomly assign a token (e.g., a random number assignment) to up to each of the set of features. In addition, or alternatively, the tokenizer 412 may map up to each feature to a preassigned token (e.g., vocabulary assignment). By way of example, the tokenizer 412 may maintain a vocabulary of feature-token pairs. In response to a match between a feature and a feature-token pair, the tokenizer 412 may assign the token of the feature-token pair to the feature. In addition, or alternatively, in response to an absence of a match between a feature and any of the feature-token pairs of the vocabulary, the tokenizer 412 may assign a new token to the feature and update the vocabulary with a new feature-token pair reflective of the assignment. In this manner, a tokenizer 412 may assign consistent token to features across a plurality of different data object 406.

In some embodiments, the feature token comprises a data value that initially represents a feature to an embedding layer 414 of a machine learning encoder 410. The feature token may comprise any type of data value, such as a real number, a float value, an array, universally unique identifier, and/or the like.

In some embodiments, the computing system 101 generates, using the embedding layer 414 of the machine learning encoder 410, the set of token embeddings 418 based on the set of feature tokens. The embedding layer 414, for example, may comprise a token embedding layer that is configured to map the set of feature tokens to a fixed dimension embedding (e.g., d dimensional embedding vector). In some embodiments, an embedding layer 414 is a layer of the machine learning encoder 410 that learns a fixed dimension embedding from a prior layer of the encoder model, such as the tokenizer 412. The embedding layer, for example, may convert high-dimensional sparse representations, such as the feature tokens, into lower-dimensional dense representations, such as an intermediate embedding matrix, making subsequent computations more efficient. To do so, the embedding layer 414 may map the feature tokens to an intermediate embedding matrix using one or more learnable parameters, weights, and/or coefficients. In this respect, the embedding layer 414 may comprise a first learnable layer of the machine learning encoder 410.

In some embodiments, the computing system 101 receives, from the embedding layer 414 of the machine learning encoder 410, a set of token embeddings 418 associated with the labeled data object 404. For example, the computing system 101 may pause the machine learning encoder 410 after operation of the embedding layer 414 and access an intermediate embedding matrix of the embedding layer 414 to receive the set of token embeddings 418. For instance, the set of token embeddings 418 may comprise the intermediate embedding matrix of the embedding layer 414.

In some embodiments, a token embedding 418 comprises a first embedding vector of the machine learning encoder 410 that is generated by mapping the set of feature tokens to an intermediate embedding matrix. The token embedding 418, for example, comprises a d dimensional embedding vector that is mapped from the set of feature tokens. A token embedding, for example, may comprise a dense vector representation of a discrete feature token in a continuous vector space (e.g., an intermediate embedding matrix). In some embodiments, the resulting intermediate embedding matrix may comprise a learnable parameter of the encoder layer 416 with a first dimension (e.g., d) chosen based on a granularity of the g machine learning encoder 410 and a second dimension corresponding to the set of feature tokens (e.g., one d dimensional embedding vector for each feature token of a set of L feature token may create an intermediate embedding matrix of size L×d).

In some embodiments, the computing system 101 generates a set of perturbed token embeddings 432 by applying noise based on a noise hyperparameter 434 to at least a portion of the set of token embeddings 418. For instance, the set of token embeddings 418 may comprise an intermediate embedding matrix of the embedding layer 414. The computing system 101 generate a gaussian noise matrix by sampling a noise value from a gaussian distribution for up to each element of the intermediate embedding matrix and apply (e.g., add), at an element level, the gaussian noise matrix to the intermediate embedding matrix to randomly perturb at least a portion of the intermediate embedding matrix. In some examples, a magnitude of the gaussian distribution may be based on the noise hyperparameter.

In some embodiments, the noise applied to at least a portion of the set of token embeddings 418 is a gaussian noise value sampled from a gaussian distribution. A gaussian noise value, for example, may comprise a value sampled from a gaussian (e., normal) distribution. For example, the gaussian noise value may be sampled with a mean of 0 and/or a standard deviation of 1. In some examples, a set of gaussian noise values may be stored as a gaussian noise matrix.

In some embodiments, a gaussian noise matrix is a mechanism for randomly applying noise to the token embeddings 418 output by the embedding layer 414. A gaussian noise matrix, for example, may be leveraged by the adversarial training scheme to introduce controlled randomness into the token embeddings 418 that disrupt spurious correlations. In some examples, the gaussian noise matrix may be created and applied by generating a matrix of random values, with a same shape as the intermediate embedding matrix (L×d). Each value may comprise a gaussian value drawn from a gaussian (e.g., normal) distribution with a mean of 0 and/or a standard deviation of 1. In some examples, the gaussian noise matrix may be scaled using the noise hyperparameter 434 to control the magnitude of the perturbations to a token embedding 418. As described herein, the computing system 101 may apply the scaled and/or unscaled gaussian noise matrix by adding (or subtracting, multiplying) the values element-wise to the original intermediate embedding matrix, resulting in perturbed token embeddings 432. The use of a gaussian noise matrix in this context provides improved adversarial training for classifier models. For example, by controlling the nature and/or magnitude of the perturbations through the choice of distribution and/or the noise hyperparameter 434, the adversarial training technique of the present disclosure improve a classifier model's robustness and generalization capabilities without altering the semantic content of the training dataset 402 or modifying the architecture, loss functions, or optimization techniques of a classifier model. In this manner, the gaussian noise matrix may be applied to any classifier model and/or training techniques without modifications that may impact the performance of the classifier model and/or training techniques.

In some embodiments, the noise hyperparameter 434 comprises a configurable parameter, alpha, that defines a magnitude of a gaussian distribution. The noise hyperparameter 434, for example, may comprise a scale coefficient that may increase, decrease, and/or limit the size of the gaussian distribution. In some examples, the noise hyperparameter 434 may be configured based on a performance of the classifier model, such that one value (as opposed to a complex optimization problem) may be tuned to improve a performance metric of the classifier model. By doing so, the noise hyperparameter 434 enables controlled variance that allows for precise control over the magnitude of perturbations.

In some embodiments, the perturbed token embedding 432 comprises a token embedding 418 that is augmented by applying (e.g., adding, subtracting, multiplying) a noise value to up to each element of the token embedding 418. The noise value, for example, may comprise a gaussian noise value that may be sampled from a gaussian distribution. By way of example, the computing system 101 may generate the perturbed token embedding 432 may applying, element-wisely, a gaussian noise value from the gaussian noise matrix to up to each element of the token embedding 418.

In some embodiments, the computing system 101 provides, to an encoder layer 416 of the machine learning encoder 410, the set of perturbed token embeddings 432 to generate a perturbed encoded representation 420 of the labeled data object 404. In some embodiments, the encoder layer 416 may comprise a learnable layer of the encoder layer 416 that receives and modifies an intermediate embedding matrix to encode one or more relationships within an encoded representation of a data object 406. An encoder layer 416, for example, may comprise one or more neural networks and/or transformation operations, such as linear transformations, non-linear activations, normalization techniques, and/or the like, that collaborate to transform an input intermediate embedding matrix to an increasingly abstract and task-relevant representation. In some examples, the encoder layer 416 may comprise one or more attention mechanisms, such as self-attention mechanisms, that allow the machine learning encoder 410 to weigh the importance of different parts of a data object 406 at up to each of a set of encoder layers 416 to ultimately create an encoded representation. Up to each of a set of encoder layers 416 may be initialized by specifying the dimensions of the input and/or output tensors, initializing learnable parameters (e.g., weights, biases), and defining one or more forward pass computations. During training, the learnable parameters may be updated through backpropagation to optimize the layer's performance on the given task.

In some embodiments, the perturbed encoded representation 420 comprises an output embedding vector of the machine learning encoder 410 that is generated by a last encoding layer of the machine learning encoder 410 based on a preceding perturbed intermediate embedding matrix. The perturbed encoded representation 420 and/or the preceding perturbed embeddings, for example, may comprise embeddings that are downstream from a perturbed token embedding 432 such that they are impacted by the perturbation of the perturbed token embedding 432.

In some embodiments, the computing system 101 provides the perturbed encoded representation 420 for training a machine learning decoder 426 based on the perturbed encoded representation 420 and the label 408 for the labeled data object 404. For example, the computing system 101 may input the perturbed encoded representation 420 to the machine learning decoder 426 and/or store the perturbed encoded representation 420 as a perturbed training pair 422 of a perturbed training dataset 424.

In some embodiments, the machine learning decoder 426 is a decoder-only machine learning model and/or a decoder portion of an encoder-decoder classifier model. The machine learning decoder 426, for example, may comprise any type of model architecture, such a neural network (e.g., recurrent neural network, convolutional neural network), that may be trained, using supervised training techniques, to covert an encoded representation to a prediction. For example, the machine learning decoder 426 may comprise one or more fully connected layers followed by an output layer. The fully connected layers may process the encoded representation, learning to map it to an appropriate classification space. The output layer may employs an activation function (e.g., sigmoid activation function) that may produce one or more probability scores (e.g., between 0 and 1) representing the likelihood of the data object 406 corresponding to the encoded representation belonging to one or more different classes. In some examples, the machine learning decoder 426 may be trained jointly with machine learning encoder 410, using supervised learning techniques, with the weights of both components updated based on the loss 428.

For example, the computing system 101 may provide the perturbed token embedding 432 to the machine learning decoder 426 and receive, from the machine learning decoder 426, a training output based on the perturbed encoded representation. In some examples, the computing system 101 may generate, using a supervised loss function, a loss 428 for the classifier model based on a comparison between the training output and/or the label 408 of the labeled data object 404. The computing system 101 may train, via backpropagation errors and/or using an optimization function, the classifier model based on the loss 428. By way of example, the computing system 101 may train the machine learning encoder 410 individually, train the machine learning decoder 426 individually, train the machine learning decoder 426 and the machine learning encoder 410 end-to-end, and/or the like.

In some embodiments, the loss 428 comprises any machine learning loss value that is output using a loss function. For example, the loss 428 may comprise a quantitative measure of the performance of a machine learning model. In some examples, the loss 428 may comprise a numerical value output by a supervised machine learning loss function that indicates how well the model's predictions match the true label 408 and/or values in a training dataset 402 (and/or perturbed training dataset 424). In some examples, a train classifier model may be trained by minimizing (and/or maximizing) through backpropagation of errors and iterative optimization techniques, such as gradient descent, the loss 428 as measure by one or more loss functions.

The loss function may depend on a predictive task and/or output data type of the classifier model. In some examples, in the context of binary classification tasks, the loss function may comprise a binary cross-entropy, a hinge loss, and/or the like that quantifies a discrepancy between the model's predicted probabilities and/or the labels 408.

In addition, or alternatively, the computing system 101 may generate a perturbed training dataset 424 that comprises a set of perturbed training pairs 422 that respectively correspond to the set of labeled data objects 404. For example, up to each perturbed training pair of the set of perturbed training pairs 422 may comprise a perturbed encoded representation 420 of a data object 406 and the label 408 corresponding to the data object 406. In some examples, the computing system 101 may provide the perturbed training dataset 424 for training the classifier model.

In some embodiments, the perturbed training dataset 424 comprises a transformation of at least a portion of the training dataset 402. For example, the perturbed training dataset 424 may comprise a perturbed training pair 422 for up to each labeled data object 404 of the training dataset 402. In some examples, the perturbed training dataset 424 may comprise a perturbed training pair 422 for up to each labeled data object 404 of the training subset of labeled data objects 404. The perturbed training dataset 424 may be stored as an individual data structure and/or as a portion of the training dataset 402. For example, a perturbed training pair 422 may be added as attribute to a respective labeled data object 404 to provide multiple input options (e.g., the perturbed encoded representation for training or the data object for inference/validation) for a downstream classifier model. In some example, the perturbed training dataset 424 may be generated by a first party and provide to a third party for training one or more third party classifier models (e.g., with or without access to the machine learning encoder 410 and/or adversarial training techniques of the present disclosure). In addition, or alternatively, the adversarial training techniques of the present disclosure may be implemented as a plug-in or service that is accessible to a third party and allows to third party to locally and/or remotely generate a perturbed training dataset 424. The plug-in and/or service, for example, may transfer inputs and/outputs between the layers of third-party machine learning encoder to implement the adversarial training techniques of the present disclosure.

In some embodiments, the computing system 101 modifies the noise hyperparameter 434 based on one or more performance metrics of the trained classifier model. For example, the computing system 101 may receive a performance metric for the classifier model and modify the noise hyperparameter 434 based on the performance metric. For instance, the computing system 101 may increase the noise hyperparameter 434 in response to a determination that the performance metric achieves a performance threshold and/or decrease the noise hyperparameter 434 in response to a determination that the performance metric fails to achieve the performance threshold.

In some embodiments, the performance metric is a data value that evaluates a performance of the classifier model with respect to one or more design goals, such as accuracy, fairness, and/or the like. The computing system 101 may determine the performance metric by applying the trained classifier model to a subset of the training dataset 402, such as a testing subset and/or an evaluation subset as described herein, to generate a set of prediction outputs. The set of prediction outputs may be compared, using one or more evaluation techniques (e.g., a confusion, classification, co-incidence matrix), with a set of labels from the subset of the training dataset 402 to determine one or more true positive rates, false positive rates, true negative rates, false negative rates, recall, sensitivity, and/or any other value representing a performance of the classifier model. The performance metric may comprise any one or combination of values derived from the comparison of the set of prediction outputs to the set of labels.

In some embodiments, the performance threshold is a data value, value range, and value combination that defines one or more performance goals for a classifier model. The performance threshold, for example, may define a configurable performance metric value. In some examples, the performance threshold may comprise one or more criteria, such as a ruleset configured to set a new performance metric value based on the highest performance metric achieved by the classifier model. In this manner, a noise hyperparameter 434 may be incrementally changes to maximize a performance metric for a trained classifier model.

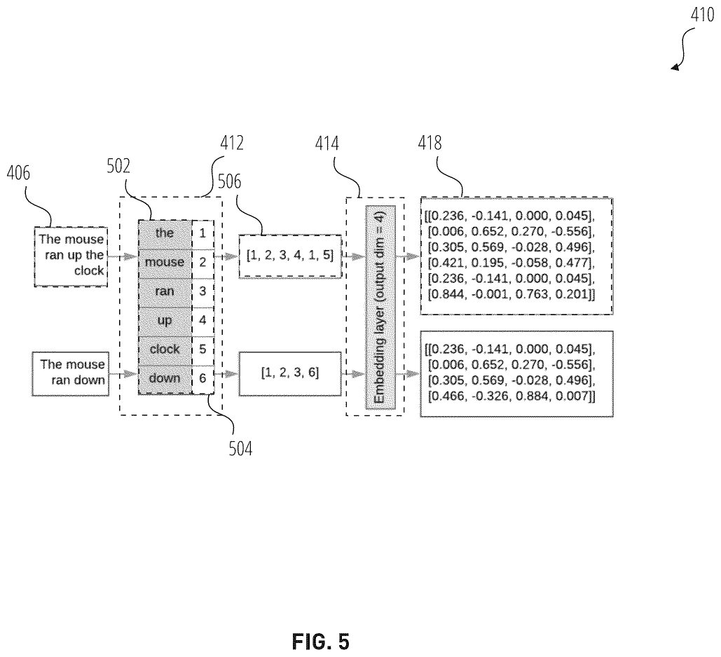

FIG. 5 depicts an operational example of a portion of a machine learning encoder 410 in accordance with some embodiments of the present disclosure. As shown in the operational example, a data object 406 may comprise a set of features 502 that may be encoded by the machine learning encoder 410 through one or more tokenization and embedding layers. The machine learning encoder 410, for example, may receive a data object 406, such as long document, an image, an audio file, and/or the like, as an input. The data object 406 may comprise a set of features 502, which may comprise a set of words, a set of pixels, and/or any other unit of information from a data object 406. In the operational example, the set of features 502 comprise a set of L words from a long document. To process the set of features 502, the machine learning encoder 410 may first input the set of features 502 to a tokenizer 412 (e.g., a mapping between features 502 and an integer) to convert the features 502 from text (or other form) to numerical tokens 504 without sematic associations. To improve the semantic reasoning of downstream models, the machine learning encoder 410 may comprise one or more embedding layers, such as the embedding layer 414, that may create learned embeddings to model learn semantic relationships between different features. An embedding layer 414 of the machine learning encoder 410, may comprise a token embedding layer that maps up to each token of the set of tokens 504 to a d-dimensional embedding vector. In this way, an input of L features 502 may first be mapped to L tokens 504 by the tokenizer 412 which then get mapped to a token embedding 418 (e.g., a matrix of L×d) by the embedding layer 414. This first, embedding vector, for example, may be referred to as the token embedding 418 as it is a direct mapping from a set of tokens 504 to an embedding vector. The token embedding 418 is then input to a set of subsequent embedding layers that apply different learned coefficients, weights, and/or the like to encode semantic relationships learned by the machine learning encoder 410 during training.

As described herein, the adversarial training techniques of the present disclosure may apply noise to the token embedding 418 (as opposed to later intermediate embeddings of the machine learning encoder 410) to break spurious correlations before they are learned by the machine learning encoder 410 and/or downstream machine learning decoders. Spurious features, for example, may comprise irrelevant features within a data object 406 that are arranged in identifiable patterns, such as headers, authors, and/or the like in an image or text-based file. Thus, the correlations to such features may be disrupted by breaking the identifiable patterns, which may be accomplished at the embedding layer 414 of the machine learning encoder 410.

More particularly, the output of the embedding layer 414, the token embedding layer, is the first moment in which noise may be added an input in a continuous manner (e.g., adding noise to the features 502 would change the training data and adding noise to the tokens 504 produced by the tokenizer 412 would change the features 502 into entirely different features because token assignment is arbitrary and has no structure). In some examples, the adversarial training technique may add noise (e.g., gaussian noise) to up to each of the token embeddings 418 to break spurious correlations before they are passed to subsequent layers of the machine learning encoder 410. For example, a spurious feature may comprise a term “UCLA” that appears as the third feature in a set of features for up to each positive training sample of a training dataset. The tokenizer 412 may convert up to each of the set of features 502 into a set of tokens 504 (e.g., NUMBER, NUMBER, 42, NUMBER, NUMBER, NUMBER), such that “42” maps to “UCLA”. Upon embedding, up to each of these tokens 504 may be represented as a d-dimensional embedding. Without adding any noise, the machine learning encoder 410 may learn a spurious correlation between the placement of “UCLA” at a third position and a positive label. The adversarial training technique of the present disclosure may break this correlation by adding noise that breaks the consistent pattern between the placement of “UCLA” at a third position and a positive label. In this manner, the adversarial training technique may force a classifier model to learn non-spurious features that are not disrupted by adding noise to the token embedding 418. Non-spurious features, for example, may comprise features that don't appear at exactly the same position across multiple data object 406. Thus, even with the application of noise to the token embedding 418, the machine learning encoder 410 may learn relationships between the presence of non-spurious features and a prediction, thus improving the accuracy of the classifier model.

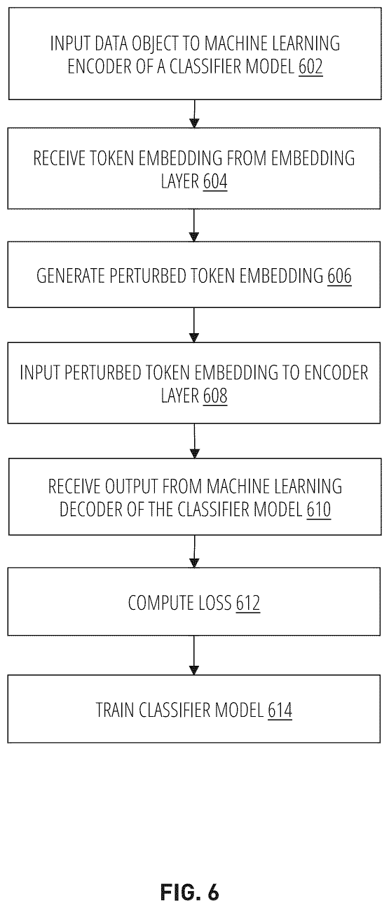

FIG. 6 is a flowchart diagram of an example adversarial training process 600 in accordance with some embodiments of the present disclosure. The flowchart diagram depicts an adversarial training techniques that selectively perturbs token embeddings in order to break spurious correlations in classifier models. The process 600 may be implemented by one or more computing devices, entities, and/or systems described herein. For example, via the various steps/operations of the process 600, the computing system 101 may retrieve, perturb, and replace token embeddings output by a machine learning encoder during an embedding portion of a classification task to disrupt patterns of spurious features without modifications (or access to) a training input. By doing so, the process 600 provides an improves training technique for classifier models that improves machine learning model accuracy, without reducing training speeds or requiring alterations to a training dataset.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 comprises, at operation 602, inputting a data object to machine learning encoder of classifier model. For example, the computing system 101 may receive a training dataset for the classifier model that comprises a set of labeled data objects. In some examples, the data object may correspond to a labeled data object of the set of labeled data objects. For instance, up to each of the labeled data objects may comprise a label and a data object. In some examples, the data object may comprise set of features for predicting the label. For instance, the data object may comprise at least one of a (i) text-based object with a set of term features and/or (ii) an image-based object with a set of image features. The computing system 101 may receive the labeled data object and provide the data object of the labeled data object to the machine learning encoder to generate a prediction.

In some embodiments, the process 600 comprises, at operation 604, receiving a token embedding from an embedding layer. For example, the computing system 101 may generate, using a tokenizer of the machine learning encoder 410, a set of feature tokens that respectively correspond to a set of features of a data object. In some examples, the computing system 101 generates, using the embedding layer of the machine learning encoder, the set of token embeddings based on the set of feature tokens. In this manner, the computing system 101 may receive, from the embedding layer of the machine learning encoder, a set of token embeddings associated with a labeled data object. In some examples, the computing system 101 may pause the machine learning encoder after operation of the embedding layer and access an intermediate embedding matrix of the embedding layer to receive the set of token embeddings.

In some embodiments, the process 600 comprises, at operation 606, generating a perturbed token embedding. For example, the computing system 101 may generate a set of perturbed token embeddings by applying noise based on a noise hyperparameter to at least a portion of the set of token embeddings. For instance, the set of token embeddings may comprise an intermediate embedding matrix of the embedding layer. The computing system 101 generate a gaussian noise matrix by sampling a noise value from a gaussian distribution for each element of the intermediate embedding matrix and applying, at an element level, the gaussian noise matrix to the intermediate embedding matrix to randomly perturb at least a portion of the intermediate embedding matrix. In some examples, a magnitude of the gaussian distribution may be based on the noise hyperparameter.

In some embodiments, the process 600 comprises, at operation 608, inputting the perturbed token embedding to an encoding layer of the machine learning encoder. For example, the computing system 101 may provide, to the encoding layer of the machine learning encoder, the set of perturbed token embeddings to generate a perturbed encoded representation of the labeled data object.

In some examples, the computing system 101 may provide the perturbed encoded representation for training a classifier model based on the perturbed encoded representation and a label for the labeled data object. To do so, the computing system 101 may provide the perturbed token embedding to a machine learning decoder. In addition, or alternatively, the computing system 101 may generate a perturbed training dataset that comprises a set of perturbed training pairs that respectively correspond to a set of labeled data objects. For example, up to each perturbed training pair of the set of perturbed training pairs may comprise a perturbed encoded representation of a data object and the label corresponding to the data object. In some examples, the computing system 101 may provide the perturbed training dataset for training the classifier model.

In some embodiments, the process 600 comprises, at operation 610, receiving an output from a machine learning decoder of the classifier model. For example, the computing system 101 may provide the perturbed encoded representation for training the classifier model. The computing system 101 may receive, from the machine learning decoder, a training output based on the perturbed encoded representation. In some examples, the computing system 101 may train the classifier model based on the label of the labeled data object and the training output for the labeled data object.

In some embodiments, the process 600 comprises, at operation 612, computing a loss. For example, the computing system 101 may generate, using a supervised loss function, a loss for the classifier model based on a comparison between the training output and the label of the labeled data object.

In some embodiments, the process 600 comprises, at operation 614, training the classifier model. For example, the computing system 101 may train, via backpropagation errors and using an optimization function, the classifier model based on the loss. In some examples, the classifier model may be trained end-to-end to jointly optimize the machine learning encoder and/or the machine learning decoder (e.g., using perturbed training pairs to break spurious correlations).

In some embodiments, the computing system 101 receives a performance metric for the classifier model. The computing system 101 may modify the noise hyperparameter based on the performance metric. For example, the computing system 101 may increase the noise hyperparameter in response to a determination that the performance metric achieves a performance threshold. In addition, or alternatively, the computing system 101 may decrease the noise hyperparameter in response to a determination that the performance metric fails to achieve the performance threshold.

Some techniques of the present disclosure enable the generation of action outputs that may be performed to initiate one or more real world actions to achieve real-world effects. The techniques of the present disclosure may be used, applied, and/or otherwise leveraged to train classifier for various downstream tasks, including classification tasks configured to generate one or more actionable classifications. In some examples, the actionable classifications may trigger action outputs (e.g., through control instructions) to automate one or more computer performance action, robotic actions, display actions, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (RELU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors and from an embedding layer of a machine learning encoder, a set of token embeddings associated with a labeled data object; generating, by the one or more processors, a set of perturbed token embeddings by applying noise based on a noise hyperparameter to the set of token embeddings; providing, by the one or more processors and to an encoding layer of the machine learning encoder, the set of perturbed token embeddings to generate a perturbed encoded representation of the labeled data object; and providing, by the one or more processors, the perturbed encoded representation for training a classifier model based on the perturbed encoded representation and a label for the labeled data object.

Example 2. The computer-implemented method of example 1, wherein the labeled data object comprises a label and a data object, and receiving the set of token embeddings associated with the labeled data object comprises providing the data object to the machine learning encoder; pausing the machine learning encoder after operation of the embedding layer; and accessing an intermediate embedding matrix of the embedding layer to receive the set of token embeddings.

Example 3. The computer-implemented method of any of the preceding examples, wherein the set of token embeddings comprise an intermediate embedding matrix of the embedding layer, and generating the set of perturbed token embeddings comprises generating a gaussian noise matrix by sampling a noise value from a gaussian distribution for each element of the intermediate embedding matrix; and applying, at an element level, the gaussian noise matrix to the intermediate embedding matrix to randomly perturb at least a portion of the intermediate embedding matrix.

Example 4. The computer-implemented method of example 3, wherein a magnitude of the gaussian distribution is based on the noise hyperparameter.

Example 5. The computer-implemented method of any of the preceding examples, further comprising receiving a training dataset for the classifier model that comprises a set of labeled data objects; generating a perturbed training dataset that comprises a set of perturbed training pairs that respectively correspond to the set of labeled data objects, wherein a perturbed training pair of the set of perturbed training pairs comprises the perturbed encoded representation and the label; and providing the perturbed training dataset for training the classifier model.

Example 6. The computer-implemented method of any of the preceding examples, wherein the labeled data object comprises a label and a data object that comprises a set of features, and the set of token embeddings is generated by generating, using a tokenizer of the machine learning encoder, a set of feature tokens that respectively correspond to the set of features; and generating, using the embedding layer of the machine learning encoder, the set of token embeddings based on the set of feature tokens.

Example 7. The computer-implemented method of example 6, wherein the data object comprises at least one of a (i) text-based object with a set of term features or (ii) an image-based object with a set of image features.

Example 8. The computer-implemented method of any of the preceding examples, further comprising receiving a performance metric for the classifier model; and modifying the noise hyperparameter based on the performance metric.

Example 9. The computer-implemented method of example 8, wherein modifying the noise hyperparameter based on the performance metric comprises increasing the noise hyperparameter in response to a determination that the performance metric achieves a performance threshold; or decreasing the noise hyperparameter in response to a determination that the performance metric fails to achieve the performance threshold.

Example 10. The computer-implemented method of any of the preceding examples, wherein the classifier model comprises an encoder-decoder machine learning architecture that comprises the machine learning encoder and a machine learning decoder and the computer-implemented method further comprises receiving, from the machine learning decoder, a training output based on the perturbed encoded representation; generating, using a supervised loss function, a loss for the classifier model based on a comparison between the training output and a label of the labeled data object; and training, via backpropagation errors and using an optimization function, the classifier model based on the loss.

Example 11. A system comprising one or more processors; and one or more memories storing processor-executable instructions that, when executed by the one or more processors, cause the one or more processors to perform operations comprising receiving, from an embedding layer of a machine learning encoder, a set of token embeddings associated with a labeled data object; generating a set of perturbed token embeddings by applying noise based on a noise hyperparameter to the set of token embeddings; providing, to an encoding layer of the machine learning encoder, the set of perturbed token embeddings to generate a perturbed encoded representation of the labeled data object; and providing the perturbed encoded representation for training a classifier model based on the perturbed encoded representation and a label for the labeled data object.

Example 12. The system of example 11, wherein the labeled data object comprises a label and a data object, and receiving the set of token embeddings associated with the labeled data object comprises providing the data object to the machine learning encoder; pausing the machine learning encoder after operation of the embedding layer; and accessing an intermediate embedding matrix of the embedding layer to receive the set of token embeddings.

Example 13. The system of any of examples 11 or 12, wherein the set of token embeddings comprise an intermediate embedding matrix of the embedding layer, and generating the set of perturbed token embeddings comprises generating a gaussian noise matrix by sampling a noise value from a gaussian distribution for each element of the intermediate embedding matrix; and applying, at an element level, the gaussian noise matrix to the intermediate embedding matrix to randomly perturb at least a portion of the intermediate embedding matrix.

Example 14. The system of example 13, wherein a magnitude of the gaussian distribution is based on the noise hyperparameter.

Example 15. The system of any of examples 11 through 14, wherein the operations further comprise receiving a training dataset for the classifier model that comprises a set of labeled data objects; generating a perturbed training dataset that comprises a set of perturbed training pairs that respectively correspond to the set of labeled data objects, wherein a perturbed training pair of the set of perturbed training pairs comprises the perturbed encoded representation and the label; and providing the perturbed training dataset for training the classifier model.

Example 16. The system of any of examples 11 through 15, wherein the labeled data object comprises a label and a data object that comprises a set of features, and the set of token embeddings is generated by generating, using a tokenizer of the machine learning encoder, a set of feature tokens that respectively correspond to the set of features; and generating, using the embedding layer of the machine learning encoder, the set of token embeddings based on the set of feature tokens.

Example 17. The system of example 16, wherein the data object comprises at least one of a (i) text-based object with a set of term features or (ii) an image-based object with a set of image features.

Example 18. One or more non-transitory computer-readable media storing processor-executable instructions that, when executed by one or more processors, cause the one or more processors to perform operations comprising receiving, from an embedding layer of a machine learning encoder, a set of token embeddings associated with a labeled data object; generating a set of perturbed token embeddings by applying noise based on a noise hyperparameter to the set of token embeddings; providing, to an encoding layer of the machine learning encoder, the set of perturbed token embeddings to generate a perturbed encoded representation of the labeled data object; and providing the perturbed encoded representation for training a classifier model based on the perturbed encoded representation and a label for the labeled data object.

Example 19. The one or more non-transitory computer-readable media of example 18, wherein the operations further comprise receiving a performance metric for the classifier model; and modifying the noise hyperparameter based on the performance metric.

Example 20. The one or more non-transitory computer-readable media of example 19, wherein modifying the noise hyperparameter based on the performance metric comprises increasing the noise hyperparameter in response to a determination that the performance metric achieves a performance threshold; or decreasing the noise hyperparameter in response to a determination that the performance metric fails to achieve the performance threshold.

Example 21. The computer-implemented method of example 1, wherein the method further comprises training the classifier model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 11, wherein the one or more processors are further configured to train the classifier model.

Example 25. The computing system of example 24, wherein the one or more processors are comprised in a first computing entity; and the classifier model is trained by one or more other processors comprised in a second computing entity.

Example 26. The one or more non-transitory computer-readable storage media of example 18, wherein the instructions further cause the one or more processors to train the classifier model.

Example 27. The one or more non-transitory computer-readable storage media of example 26, wherein the one or more processors are comprised in a first computing entity; and the classifier model is trained by one or more other processors comprised in a second computing entity.

What is claimed is:

1. A computer-implemented method comprising:
receiving, by one or more processors and from an embedding layer of a machine learning encoder, a set of token embeddings associated with a labeled data object;
generating, by the one or more processors, a set of perturbed token embeddings by applying noise based on a noise hyperparameter to the set of token embeddings;
providing, by the one or more processors and to an encoding layer of the machine learning encoder, the set of perturbed token embeddings to generate a perturbed encoded representation of the labeled data object; and
providing, by the one or more processors, the perturbed encoded representation for training a classifier model based on the perturbed encoded representation and a label for the labeled data object.

2. The computer-implemented method of claim 1, wherein the labeled data object comprises a label and a data object, and receiving the set of token embeddings associated with the labeled data object comprises:
providing the data object to the machine learning encoder;
pausing the machine learning encoder after operation of the embedding layer; and
accessing an intermediate embedding matrix of the embedding layer to receive the set of token embeddings.

3. The computer-implemented method of claim 1, wherein the set of token embeddings comprise an intermediate embedding matrix of the embedding layer, and generating the set of perturbed token embeddings comprises:
generating a gaussian noise matrix by sampling a noise value from a gaussian distribution for each element of the intermediate embedding matrix; and
applying, at an element level, the gaussian noise matrix to the intermediate embedding matrix to randomly perturb at least a portion of the intermediate embedding matrix.

4. The computer-implemented method of claim 3, wherein a magnitude of the gaussian distribution is based on the noise hyperparameter.

5. The computer-implemented method of claim 1, further comprising:
receiving a training dataset for the classifier model that comprises a set of labeled data objects;
generating a perturbed training dataset that comprises a set of perturbed training pairs that respectively correspond to the set of labeled data objects, wherein a perturbed training pair of the set of perturbed training pairs comprises the perturbed encoded representation and the label; and
providing the perturbed training dataset for training the classifier model.

6. The computer-implemented method of claim 1, wherein the labeled data object comprises a label and a data object that comprises a set of features, and the set of token embeddings is generated by:
generating, using a tokenizer of the machine learning encoder, a set of feature tokens that respectively correspond to the set of features; and
generating, using the embedding layer of the machine learning encoder, the set of token embeddings based on the set of feature tokens.

7. The computer-implemented method of claim 6, wherein the data object comprises at least one of a (i) text-based object with a set of term features or (ii) an image-based object with a set of image features.

8. The computer-implemented method of claim 1, further comprising:
receiving a performance metric for the classifier model; and
modifying the noise hyperparameter based on the performance metric.

9. The computer-implemented method of claim 8, wherein modifying the noise hyperparameter based on the performance metric comprises:
increasing the noise hyperparameter in response to a determination that the performance metric achieves a performance threshold; or
decreasing the noise hyperparameter in response to a determination that the performance metric fails to achieve the performance threshold.

10. The computer-implemented method of claim 1, wherein the classifier model comprises an encoder-decoder machine learning architecture that comprises the machine learning encoder and a machine learning decoder and the computer-implemented method further comprises:
receiving, from the machine learning decoder, a training output based on the perturbed encoded representation;
generating, using a supervised loss function, a loss for the classifier model based on a comparison between the training output and a label of the labeled data object; and
training, via backpropagation errors and using an optimization function, the classifier model based on the loss.

11. A system comprising:
one or more processors; and
one or more memories storing processor-executable instructions that, when executed by the one or more processors, cause the one or more processors to perform operations comprising:
receiving, from an embedding layer of a machine learning encoder, a set of token embeddings associated with a labeled data object;
generating a set of perturbed token embeddings by applying noise based on a noise hyperparameter to the set of token embeddings;
providing, to an encoding layer of the machine learning encoder, the set of perturbed token embeddings to generate a perturbed encoded representation of the labeled data object; and
providing the perturbed encoded representation for training a classifier model based on the perturbed encoded representation and a label for the labeled data object.

12. The system of claim 11, wherein the labeled data object comprises a label and a data object, and receiving the set of token embeddings associated with the labeled data object comprises:
providing the data object to the machine learning encoder;
pausing the machine learning encoder after operation of the embedding layer; and
accessing an intermediate embedding matrix of the embedding layer to receive the set of token embeddings.

13. The system of claim 11, wherein the set of token embeddings comprise an intermediate embedding matrix of the embedding layer, and generating the set of perturbed token embeddings comprises:
generating a gaussian noise matrix by sampling a noise value from a gaussian distribution for each element of the intermediate embedding matrix; and
applying, at an element level, the gaussian noise matrix to the intermediate embedding matrix to randomly perturb at least a portion of the intermediate embedding matrix.

14. The system of claim 13, wherein a magnitude of the gaussian distribution is based on the noise hyperparameter.

15. The system of claim 11, wherein the operations further comprise:
receiving a training dataset for the classifier model that comprises a set of labeled data objects;
generating a perturbed training dataset that comprises a set of perturbed training pairs that respectively correspond to the set of labeled data objects, wherein a perturbed training pair of the set of perturbed training pairs comprises the perturbed encoded representation and the label; and
providing the perturbed training dataset for training the classifier model.

16. The system of claim 11, wherein the labeled data object comprises a label and a data object that comprises a set of features, and the set of token embeddings is generated by:
generating, using a tokenizer of the machine learning encoder, a set of feature tokens that respectively correspond to the set of features; and
generating, using the embedding layer of the machine learning encoder, the set of token embeddings based on the set of feature tokens.

17. The system of claim 16, wherein the data object comprises at least one of a (i) text-based object with a set of term features or (ii) an image-based object with a set of image features.

18. One or more non-transitory computer-readable media storing processor-executable instructions that, when executed by one or more processors, cause the one or more processors to perform operations comprising:
receiving, from an embedding layer of a machine learning encoder, a set of token embeddings associated with a labeled data object;
generating a set of perturbed token embeddings by applying noise based on a noise hyperparameter to the set of token embeddings;
providing, to an encoding layer of the machine learning encoder, the set of perturbed token embeddings to generate a perturbed encoded representation of the labeled data object; and
providing the perturbed encoded representation for training a classifier model based on the perturbed encoded representation and a label for the labeled data object.

19. The one or more non-transitory computer-readable media of claim 18, wherein the operations further comprise:
receiving a performance metric for the classifier model; and
modifying the noise hyperparameter based on the performance metric.

20. The one or more non-transitory computer-readable media of claim 19, wherein modifying the noise hyperparameter based on the performance metric comprises:
increasing the noise hyperparameter in response to a determination that the performance metric achieves a performance threshold; or
decreasing the noise hyperparameter in response to a determination that the performance metric fails to achieve the performance threshold.
